(19) United States
(12) Patent Application Publication
(10) Pub. No.: US 2010/0121706 A1
(43) Pub. Date: May 13, 2010

(54) METHOD AND SYSTEM FOR SELECTING ADVERTISEMENTS

(75) Inventors: Jeffrey Arena, San Francisco, CA (US); Melissa B. Stein, Sherman Oaks, CA (US); Jianchang (JC) Mao, San Jose, CA (US); Vanja Josifovski, Los Gatos, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/269,365

(22) Filed: Nov. 12, 2008

(51) Int. Cl. G06Q 30/00; G06Q 40/00; G06Q 90/00

(52) U.S. Cl. 705/14.49; 705/37

(57) ABSTRACT

A system for selecting advertisements for a web page. The system includes an advertisement serving and optimization engine that receives an advertisement request. The advertisement serving and optimization engine evaluates the web page and identifies content attributes based on the content of the web page. The advertisement serving and optimization engine accesses a database that stores an association between the content attribute and an advertisement attribute, where the advertisement attribute is not lexically related to the content attribute. An association engine is also in communication with the database to define and store the attribute association between the advertisement attribute and the content attribute. The association engine generates attribute associations by evaluating external data sources. The advertisement attribute is used to retrieve advertisement results for display on the web page.

### BACKGROUND

One form of revenue for search engines and content providers are advertisements that are displayed on the pages of websites. These advertisements may take the form of banner advertisements, advertisement lists, or other commonly known advertisements. One form of advertising on web pages is referred to as contextual advertisement. In contextual advertising, advertisements are requested for a specific web page based on the content of that web page. The web page content is analyzed to identify content attributes. The content attributes are used to identify which advertisements best match the content for the web page.

However, the direct use of the content attributes often leads to a narrow category of advertisements being served for each page. For example, often a web page with content related to golf may only receive advertisements related to golf. However, the user may have numerous other interests in addition to golf. If only golf advertisements are served, advertisers selling products or services related to those other interests may miss an opportunity to present an advertisement to that user.

### SUMMARY

The present application describes a system and method for allowing advertisers to expand advertising opportunities. The system includes an advertisement serving and optimization engine that receives an advertisement request. The advertisement serving and optimization engine evaluates the web page and identifies content attributes based on the content of the web page. The content attributes may, for example be in the form of terms, phrases, categories, unigrams, or other attributes. Further, the content attributes may include page attributes, publisher attributes, or a combination thereof. The advertisement serving and optimization engine accesses a database that stores an advertisement attribute associated with the content attribute, where the advertisement attribute is not lexically related to the content attribute. An association engine is also in communication with the database to store the attribute associations between advertisement attributes and content attributes. The association engine communicates with external data sources to generate associations between content attributes and advertisement attributes by evaluating the relationship of the attributes in the external data sources. The advertisement attribute is then used to retrieve advertisement results for display on the web page.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

FIG. 1 is a schematic view of a system for selecting advertisements for a web page;

FIG. 2 is a flow chart illustrating a method for selecting advertisements for a web page;

FIG. 3 is a flow chart illustrating another method for selecting advertisements for a web page; and

FIG. 4 is a schematic view of a computer system for implementing the methods described.

### DETAILED DESCRIPTION

In contextual advertising, advertisements selected based on the content of the web page often relate to similar products or services. For example, a web page on sports might be served with advertisements only related to sports equipment or events. That is because the term “sports” from the web page is identified as a content attribute. Then the content attribute (“sports”) is matched to the advertisement attribute (“sports”). Therefore, the page and advertisement are lexically matched. However, serving ads to a site based on a lexically unrelated topic may provide certain advantages. For example, an LCD TV maker knows that sports site visitors are a good market for large screen LCD TV's. However, with typical contextual matching a TV advertiser only has a good chance of showing up (because of relevancy) if the sports page talks about TVs, which is a rare occurrence.

Accordingly, the system and method described in this application establishes latent links between lexically unrelated online objects in a cost-effective manner. The proposed approach can employ a set of collaborative filters that operate on historical data from various online applications to discover possible associations between online objects (i.e., terms, topics, user attributes). Such online applications include social media (wikipedia, Y! Answers, eBay Guides, eHow Wiki, etc), related searches (eBay, Shopzilla), web search, sponsored search, contextual advertising, and display advertising.

The mining process to identify and map the associations may occur offline or can be continuously updated. The association map between online objects that was discovered in the mining process can then be used to provide recommendations for advertiser to target certain types of content and users, and/or to retrieve a set of exploratory ads that link to a given opportunity. Each exploratory advertisement may reserve a number of slots in an ad slate for randomized inclusion.

After an exploration period, data mining and machine learning techniques can be used to discover the strength of the latent links using historical performance data. The proposed approach reduces the scope of exploration (ad impressions) so that historical performance data can be built up rapidly without significant opportunity cost. This provides a cost-effective way to discover what type of publisher sites and users perform well with specific types of advertisements.

The system may also allow advertisers to express advertisement intention via advertisement attributes, such as bid terms. The bid terms may be lexically unrelated to an ad, so that a contextual ad serving system can serve an advertisement on publisher pages where content does not lexically match an advertisement topic. For example, a LCD TV maker/advertiser could bid for common sports vocabulary that appears on sports pages. This approach is most effective for advertisers that know exactly what type of publisher sites and users to target with their ads. Typically, this approach is less effective for small advertisers who have very limited resources for optimizing an ad campaign.

The system may also employ data mining and machine learning techniques to automatically discover latent links using historical performance data. For example, if an ad about a luxury watch got a high click-through-rate on a golf site, data mining and machine learning algorithms may be able to discover a Luxury Watch-Golf link. However, in order for data mining and machine learning algorithms to discover such a link, the ad has to be shown a sufficiently large number of times on a site. Without a system to identify potential links, one would have to serve the Luxury Watch ad on all the possible publisher sites in order to collect performance data, which is prohibitive in cost.

Using an automated mechanism to identify latent links provides a lower cost option for implementing such a system. In addition, advertiser reach is increased for those advertisers who are unable to establish these latent links between lexically unrelated online objects via their own knowledge or resources. Further, the publisher monetization potential is increased from deeper demand pools created by additional advertiser depth in those areas where the system has established links between lexically unrelated online objects.

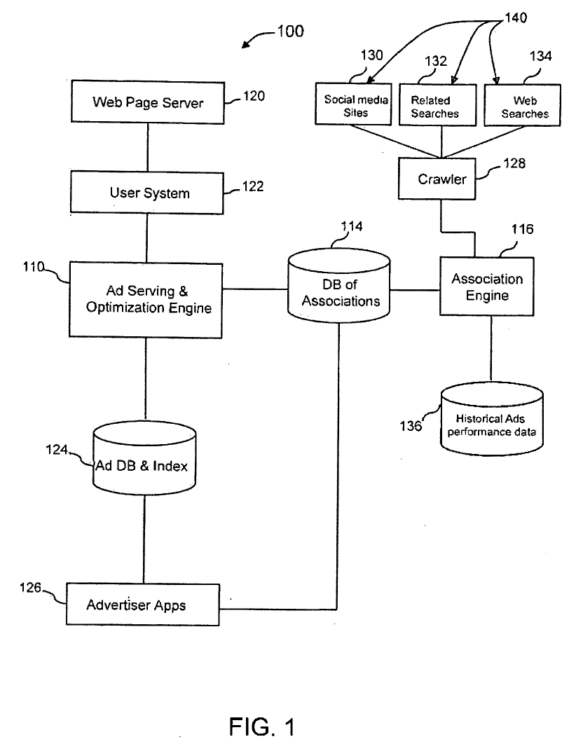

Now referring to FIG. 1, a system 100 is provided for selecting advertisements. The system 100 establishes latent links between lexically unrelated on-line objects in a cost effective manner. The system includes an advertisement serving and optimization engine 110, a database 114 and an association engine 116. The advertisement serving and optimization engine 110 is in communication with a web page server 120 through a local area or wide area network. In a common example, the web page server 120 is accessed by a user system 122 that requests a web page. The user system 122 communicates over a wide area network such as the internet with the web page server 120. Accordingly, the web page server 120 provides the user system 122 with web page content and/or an executable code such as Java Script for use in the user system 122. As described above, many web pages provide multiple advertisements to the user. As such, the web page may request advertisements from the advertisement serving and optimization engine 110 over an internet connection.

The advertisement serving and optimization engine 110 may have access to the web page content with which the advertisement may be placed. Accordingly, the advertisement serving and optimization engine 110 may identify attributes, such as terms, words or phrases from the web page content to identify a user interest. The advertisement serving and optimization engine 110 may map the user interest to a related user interest that is not lexically related, but is based on the associations defined by the database 114. The database 114 may include a plurality of predefined relationships between content attributes found in the web page content and lexically unrelated advertisement attributes where the associations are predetermined by an association engine 116 analyzing external data sources 140.

The external data sources 140 may include on-line applications such as social media sites 130, related searches 132, web searches 134, or historical ad performance data 136. Lately, social media sites 130 have begun to emerge where users can provide content including, for example, the definition of various attributes. Since a wide cross-section of interested public may contribute to the content of the social media sites 130, these sites may provide a broader perspective on how the public at large relates to various terms, attributes or concepts.

Related searches 132 may include various on-line store fronts where searches are provided for various product types. Examples of related search sites 132 include eBay, Shopzilia, or Amazon.com. In addition, web searches 134 and various related advertisements may also be examined by the association engine 116 in determining lexically unrelated attributes that have a high correlation. Some of the related facilities may include sponsored search, contextual advertising, and display advertising. In addition, historical advertisement performance data 136 may be accessed by the association engine 116 to analyze the previously used attributes to identify links between non-lexically related attributes.

The association engine 116 may access the social media sites 130, the related search sites 132, and web searches 134 through a web crawler 128 that automatically finds and tracks web content across the internet. The tracked web content may be provided systematically to the association engine 116, allowing the association engine 116 to determine latent links in lexically unrelated attributes based on the relative placement and emphasis of terms or phrases in the above-noted forms of web content. The pairs of lexically unrelated attributes may be stored as an entry in the database 114 together with the strength of the attribute association based on their frequency and relative position within various content. Accordingly, the advertisement serving and optimization engine 110 may access the database 114 and retrieve an attribute association identified from the content attribute. The attribute association may be used to identify lexically unrelated advertisement attributes prior to requesting an advertisement from the advertisement database and index 124.

In one scenario, the web page might directly request an advertisement from an advertisement engine based on the content attributes in the web page content. However, the advertisement serving and optimization engine 110 may also insert exploratory advertisements based on the associations in the database 114. If the advertisement serving and optimization engine 110 identifies a content attribute with associated advertisement attributes in the database 114, the advertisement serving and optimization engine 110 may also request exploratory advertisements based on the associated attributes. The advertisement serving and optimization engine 110 may request an exploratory advertisement from the advertisement database 124 based on an associated attribute, such as a term, phrase or taxonomy. The advertisement serving and optimization engine 110, in turn, provides the advertisement to the web page on the user system 122.

An advertiser application 126 may be provided allowing the advertisers to bid for the placement of various advertisements. The advertiser application 126 may allow the advertisers to bid on advertisements according to the associated attributes, such as bid terms or predefined advertisement taxonomies. As such, the advertiser application 126 may access the database 114 to display the associations identified by the association engine 116 and the click through rate of the exploratory advertisements served based on the associations.

However, as the association engine 116 identifies lexically unrelated attributes with a high frequency, advertisers may provide exploratory advertisements and bids to test the effectiveness of the associated attributes provided by the association engine 116. As such, the advertisement serving and optimization engine 110 may insert exploratory advertisements when an appropriate attribute is identified in the content of the web page according to a proportion of the advertising candidates. As such, advertisement serving and optimization engine 110 may in one embodiment insert a small percentage of exploratory advertisements of the overall number of advertisements to test the association of lexically unrelated attributes identified by the association engine 116.

As such, the advertiser is provided with a mechanism to identify and test new associations allowing access to additional advertisement opportunities that would otherwise not be available to the advertiser. In addition, the advertisement serving and optimization engine 110 communicates with the web page server 120 to identify whether the advertisement was selected by the user and store statistical information into the database 114. The statistical information may include user feedback, such as, a click through rate for each association stored in the database. The advertisement serving and optimization engine 110 may increase the proportion of advertisements for a particular association based on the click through rate of that association.

Increasing the opportunities for advertisers to bid may provide a better click through rate for each advertisement as the advertisement may be better matched to the particular user interest. In addition, the user is better served by providing advertisements that are typically of more interest to the user, while alternatively providing ads with better click through rates provides better value to the advertiser and more revenue to the company serving the advertisements. The associations may be used to link attributes of similar interest using advertisement attributes in conjunction with or in place of the content attributes from the web page content.

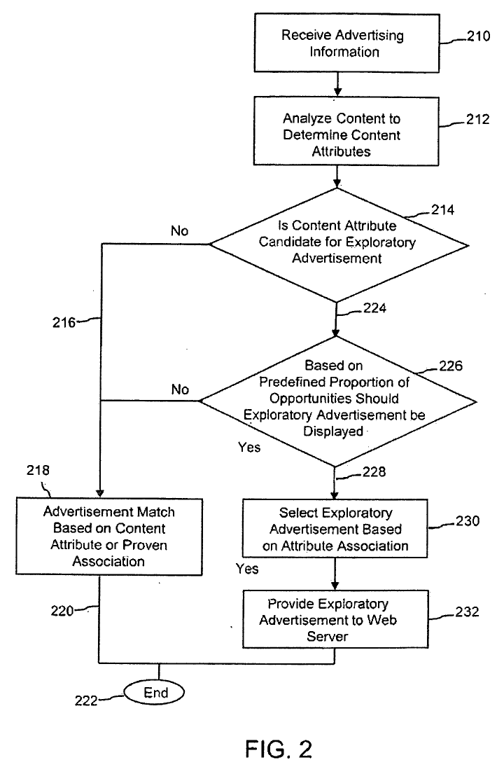

Now referring to FIG. 2, a method 200 is provided for selecting advertisements. The method 200 may be used, for example, in connection with the system 100. In block 210, an advertising request is received from a web page. The advertisement request may include or be accompanied by access to the web page content. In block 212, the web page content is analyzed to determine content attributes, such as keywords, representative of the web page content. While this example will refer to attributes, more specifically keywords, terms, phrases, or taxonomies may be utilized. The content attributes are selected in a manner such that the content attributes infer a user interest that may be paired with an appropriate advertisement.

In block 214, the system determines if the content attributes are candidates for an exploratory advertisement. The web page may be a candidate for an exploratory advertisement if the content attributes are associated to advertisement attributes stored in the database. As described above, the database may be created by identifying associations between attributes through the relative placement of terms or frequency of the terms in external sources. If the content attributes are not a candidate for an exploratory advertisement, the method follows line 216 to block 218. In block 218, an advertisement is matched with the web page based on the content attributes, for example a subject matter taxonomy, or a proven association. The method then follows line 220 and ends in block 222.

Referring again to block 214, if the content attributes are candidates for an exploratory advertisement, the method follows line 224 to block 226. In block 226, the system determines if an exploratory advertisement should be displayed based on a predefined portion of opportunities for exploratory advertisements. As such, exploratory advertisements may be tested during a small percentage of opportunities during an initial phase allowing the system to identify the strength of association between lexically unrelated attributes based on the results of the exploratory advertisements. At the same time, by mixing a small percentage of exploratory advertisements in with the normal process, ongoing revenues and service to the user are not significantly affected. If the exploratory advertisement is not to be displayed based on the predefined proportion of opportunities, the method follows line 216 to block 218. In block 218, the advertisement is matched based on content attributes and the method ends in block 222.

Referring again to block 226, if the exploratory advertisement is to be displayed based on the predefined proportion of opportunities, the method follows line 228 to block 230. In block 230, the system selects an exploratory advertisement based on the associations that are stored in the association database. In block 232, the exploratory advertisement is provided to the web server for display to the user and the method ends in block 222.

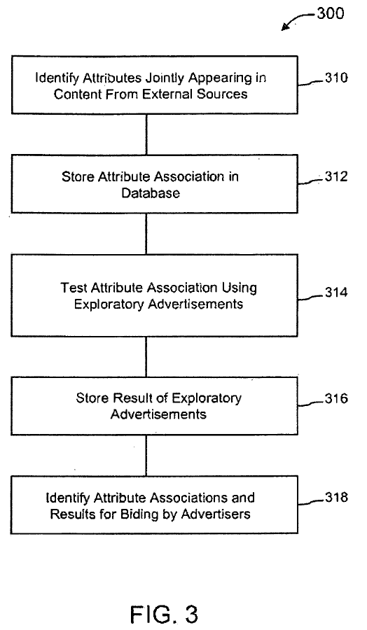

Now referring to FIG. 3, a method 300 for identifying associations is provided. In block 310, attributes are identified that jointly appear in content from external sources. In one embodiment, an association engine may access web browser histories or utilize a web crawler to identify jointly appearing attributes that may be linked together in attribute associations based on factors such as the relational placement of the attributes or the frequency with which the attributes are used together. In block 312, the system stores the association of attributes in a database. In block 314, the system may receive a request for an advertisement. As such, the system may test an association by providing an exploratory advertisement based on the attribute associations.

In block 316, results of the exploratory advertisements are stored in the database with regard to the association used. The results may be stored in the form of a click through rate or similar statistic that is indicative of the success of the association being related to a user interest. If the exploratory advertisement related to the association provides a high click through rate, the system may inform the advertisers to bid on such associations. Accordingly, in block 318, the associations and results are displayed to the advertisers. In addition, the advertisers may be allowed to bid on associations with high click through rates. Further, the click through rates may be used to identify suggested associations for bidding based on an advertiser's current bid. For example, if an advertiser currently bids on an LCD TV and the association of LCD TV and sports shows a high click through rate for exploratory advertisements, then bidding on sports may be suggested to the LCD TV advertiser. After a predefined testing period, the exploratory advertisements will no longer be inserted into the normal flow of contextual advertisements that are provided to the web server based on the related content.

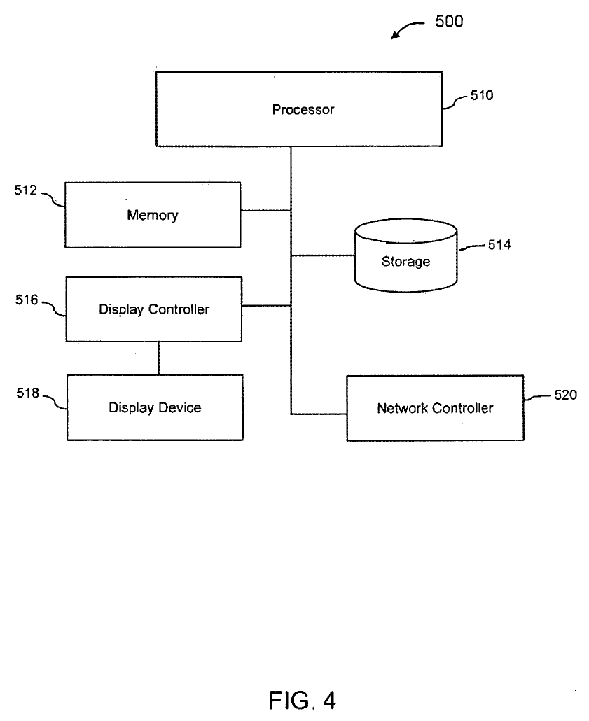

Any of the modules, servers, or engines described may be implemented in one or more general computer systems. One exemplary system is provided in FIG. 4. The computer system 500 includes a processor 510 for executing instructions such as those described in the methods discussed above. The instructions may be stored in a computer readable medium such as memory 512 or a storage device 514, for example a disk drive, CD, or DVD. The computer may include a display controller 516 responsive to instructions to generate a textual or graphical display on a display device 518, for example a computer monitor. In addition, the processor 510 may communicate with a network controller 520 to communicate data or instructions to other systems, for example other general computer systems. The network controller 520 may communicate over Ethernet or other known protocols to distribute processing or provide remote access to information over a variety of network topologies, including local area networks, wide area networks, the internet, or other commonly used network topologies.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. A system for selecting advertisements for a web page served by a web page server, the system comprising:
an advertisement serving and optimization engine receiving an advertisement request from the web page server, the advertisement serving and optimization engine evaluating the web page served by the web page server to identify content attributes based on content of the web page;
a database in communication with the advertisement serving and optimization engine, the database storing an attribute association between advertisement attributes and the content attributes where the advertisement attributes are not lexically related to the content attributes, the advertisement serving and optimization engine selecting an advertisement based on the attribute association and providing the advertisement to the web page server; and
an association engine in communication with the database, the association engine being in communication with external data sources to generate the attribute association by evaluating the external data sources.

2. The system according to claim 1, wherein the advertisement serving and optimization engine identifies exploratory advertisements based on the attribute association.

3. The system according to claim 2, wherein the advertisement serving and optimization engine stores exploratory advertisement statistics in the database.

4. The system according to claim 3, wherein the exploratory advertisement statistics includes a click through rate.

5. The system according to claim 3, further comprising an advertiser application in communication with the database to display exploratory advertisement statistics regarding the attribute association.

6. The system according to claim 3, wherein the advertiser application identifies bid candidates based on the exploratory advertisement statistics.

7. The system according to claim 1, wherein the external sources include social media sites.

8. The system according to claim 1, wherein the external sources include related search sites.

9. The system according to claim 1, wherein the external sources include user browsing histories.

10. The system according to claim 1, wherein the external sources include web search sites.

11. A method for selecting advertisements for a web page served by a web page server, the method comprising:
receiving an advertisement request;
evaluating web page content;
identifying content attributes based on the web page content;
generating an attribute association by evaluating external data sources;
storing the attribute association between advertisement attributes and the content attributes where the advertisement attributes are lexically unrelated to the content attributes;
selecting the advertisement attributes based on the attribute association with the content attributes; and
providing advertisements based on the advertisement attributes.

12. The method according to claim 11, wherein exploratory advertisements are identified based on the attribute association.

13. The method according to claim 12, wherein exploratory advertisement statistics are stored in a database.

14. The method according to claim 13, wherein the exploratory advertisement statistics include a click through rate.

15. The method according to claim 13, further comprising displaying the exploratory advertisement statistics with the attribute association.

16. The method according to claim 13, further comprising identifying bid candidates based on the exploratory advertisement statistics.

17. A computer readable medium having stored therein instructions executable by a programmed processor for ranking results, the computer readable medium comprising instructions for:
receiving an advertisement request;
evaluating web page content;
identifying content attributes based on the web page content;
generating an attribute association by evaluating external data sources;
storing the attribute association between advertisement attributes and the content attributes where the advertisement attributes are lexically unrelated to the content attributes;
selecting the advertisement attributes based on the attribute association with the content attributes; and
providing advertisements based on the advertisement attributes.

18. The method according to claim 17, wherein exploratory advertisements are identified based on the attribute association.

19. The method according to claim 18, wherein exploratory advertisement statistics are stored in a database.

20. The method according to claim 19, wherein the exploratory advertisement statistics include a click through rate.

21. The method according to claim 19, further comprising displaying the exploratory advertisement statistics with the attribute association.

22. The method according to claim 19, further comprising identifying bid candidates based on the exploratory advertisement statistics.
